(19) United States
(12) Patent Application Publication
(10) Pub. No.: US 2023/0342864 A1
(43) Pub. Date: Oct. 26, 2023

(54) SYSTEM AND METHOD FOR AUTOMATICALLY RESPONDING TO NEGATIVE CONTENT

(71) Applicant: NICE Ltd., Ra'anana (IL)

(72) Inventors: Niranjan BAGADE, Pune (IN); Tanmay PATWARDHAN, Pune (IN); Tom OTVOS, Ontario (CA)

(73) Assignee: NICE Ltd., Ra'anana (IL)

(21) Appl. No.: 17/727,215

(22) Filed: Apr. 22, 2022

(51) Int. Cl. G06Q 50/00; G06F 16/903; G06F 40/30

(52) U.S. Cl. CPC G06Q 50/01; G06F 16/90335; G06F 40/30; H04L 51/52

(57) ABSTRACT

A computer based system and method for automatically transmitting an electronic notice to a publisher of negative content, that includes: monitoring at least one electronic social media channel to identify content that is relevant to an entity; analyzing the identified content to identify content with negative sentiment, and an identity of the publisher of the content with the negative sentiment; and initiating an automated interaction with the publisher. Initiating the interaction may include posting an automatic reply to a message in the electronic social media channel that includes the content with the negative sentiment and/or initiating an automatic phone call.

### FIELD OF THE INVENTION

The invention relates generally to technology for automatically responding to negative public content, for example content in social networks.

### BACKGROUND OF THE INVENTION

Companies may want to identify frustration, complaints or dissatisfaction of clients or customers (clients and customers will be used interchangeably herein to refer to any person or organization that buys products or services from another entity or organization). Companies and organizations may have call centers for interacting with clients. The call centers, also referred to as contact centers) may create and store interactions, which may be conversations or data exchanged between, typically, an agent or representative (typically human) of the company and a customer. Interactions may include, for example, voice, audio or video recordings of conversations, and/or other data such as text, e-mail or instant messaging exchanges.

Organizations that operate call centers may identify frustration, complaints or dissatisfaction of customers that is expressed in call-center interactions either manually or automatically, e.g., by the agent participating in the interaction, by a supervisor that is reviewing the interaction, or using automatic analysis techniques for detecting complaints. However, while organizations may have analytics from the call-center interactions, they may have no insight of content published by unhappy customers in on-line public or other forums, such as product review sites or social media channels. Nevertheless, negative social media comments may seriously damage the reputation of the organization.

Therefore, a method for detecting and replying to negative content in social networks and other fora is required.

### SUMMARY OF THE INVENTION

According to embodiments of the invention, a computer-based system and method for automatically transmitting electronic notice to a publisher of negative content may include, using a processor: monitoring, by an automated process executed by the processor, at least one electronic social media channel to identify content that is relevant to an entity; analyzing, by the automated process, the identified content to identify content with negative sentiment, and the publisher of the content with the negative sentiment; and initiating, by the automated process, an automated interaction with the publisher.

According to embodiments of the invention, initiating the interaction may include at least one of: posting an automatic reply to a message in the electronic social media channel that includes the content with the negative sentiment or initiating an automatic phone call.

Embodiments of the invention may include analyzing the content with the negative sentiment to identify a problem; and adjusting the initiated interaction according to the identified problem.

According to embodiments of the invention, analyzing the content with the negative sentiment to identify the problem may include: extracting keywords from the content with the negative sentiment; and using the keywords as search terms to query a database of known problems to identify the problem.

According to embodiments of the invention, the database of known problems may include mitigations to the problems, and adjusting the initiated interaction may include: retrieving from the database of known problems a mitigation that is associated with the identified problem; and including the mitigation in a response to a message in the social media channel that includes the content with the negative sentiment.

Embodiments of the invention may include finding an identity of the publisher in a customer database of the entity; and adjusting the initiated interaction according to the identity of the publisher.

According to embodiments of the invention, finding the identity of the publisher may include: extracting attributes from a profile of the publisher, wherein each attribute is associated with an importance level; selecting at least one of the attributes based on the importance level of the attributes; using the selected attributes as keywords for searching the customer database for an identity of the publisher; and associating a confidence score to the identity of the publisher, wherein the confidence score is indicative of chances that the identification is correct.

According to embodiments of the invention, monitoring at least one social media channel may include accessing the publicly accessible content that includes a tag or a hashtag relating to the entity.

According to embodiments of the invention, monitoring at least one social media channel may include: finding a first post on the at least one social media channel that includes at least part of the content that is relevant to the entity; finding related posts by the same publisher; finding responses to the first post and to the related posts; extracting keywords from the first post, the related posts and the responses; and providing the keywords to a machine learning (ML) model that has been trained to identify sentiment from the keywords and a confidence level of the identified sentiment.

Embodiments of the invention may include analyzing, by the automated process, the content with the negative sentiment to identify a problem; retrieving, by the automated process, from a client database, a communication channel and contact information of the publisher; retrieving, by the automated process, from a database of known problems a mitigation that is associated with the identified problem; and scheduling, by the automated process, a work item for an agent, wherein the work item comprises the communication channel, the contact information and the mitigation.

Embodiments of the invention may include selecting, by the automated process, from a database of agents and associated skills, the agent that is associated with skills relevant to at least one of the problem, the publisher and the communication channel.

According to embodiments of the invention, a computer-based system and method for automatically responding to negative content may include: automatically monitoring, by a processor, an electronic social media platform to find publicly available content that is related to a company; categorizing, by the processor, the publicly available content that is related to the company to as negative or neutral; and posting, by the processor, an automatic reply to at least one post that includes the content that is categorized as negative.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of a system for automatically responding to negative content in social network, according to embodiments of the present invention.

FIG. 2 is a high-level block diagram of an analysis center, according to embodiments of the present invention.

FIG. 3 is a high-level block diagram of an exemplary computing device which may be used with embodiments of the present invention.

FIG. 4 is a flowchart of a method for automatically transmitting an electronic notice to a publisher of negative content, according to embodiments of the present invention.

FIG. 5 is a flowchart of a second method for automatically transmitting an electronic notice to a publisher of negative content, according to embodiments of the present invention.

FIG. 6 is an example of a screenshot of a social media channel, according to embodiments of the invention.

FIG. 7 is a second example of a screenshot of a social media channel, according to embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

Embodiments of the invention may have a computerized process that monitors electronic on-line media a such as social media channels to identify content that is relevant to an entity or an organization, analyze the identified content to further identify content with negative sentiment, identify the publisher of the content with the negative sentiment, and automatically initiate an automated interaction with the publisher. When discussed herein, a publisher may be a person who posts or creates a social media post or content, often via a social media platform or channel or other channel, such as a product review website, the Facebook® or Twitter® social media sites, or the Yelp® review website.

According to embodiments of the invention, the automated interaction may include a reply that is automatically posted as a response to a post with the negative content. If a specific problem is not identified, the automated response may include some general language, for example, a response may include general empathetic language and a suggestion to contact the call center. In some cases, if a problem is identified, then the response may include a specific mitigation that suits the problem. If the publisher of the negative content is identified in a customer database of the organization, the initiated interaction may be adjusted or tailored according to the identity of the publisher. For example, an agent that is familiar with the caller, with the problem or is otherwise suitable may be automatically identified and a work item may be automatically scheduled for that agent, e.g., to proactively contact the publisher of the negative content.

Embodiments of the invention may improve call center or automatic human-computer interaction technology by incorporating more aspects of client management and content management to such interactions or call centers. By automatically monitoring social media, and by providing automatic recognition and mitigation of negative content, embodiments of the invention may provide automatic procedures that may improve client relationship, and may extend coverage of call centers beyond communication that is performed directly with the call center. Thus, embodiments of the invention may enable identifying and reaching out to unhappy clients in a fully automated way through normal contact center workflow. In addition, embodiments of the invention may enable generating client-specific content, including knowledge base content, where appropriate, to ensure focused communication with the unhappy client.

While embodiments of the invention are described mainly with relation to organizations that operate a contact center, this is not limiting, and some embodiments of the invention may be implemented by organizations that do not operate a contact center. For example, such organizations may monitor an electronic social media channel to identify content that is relevant to an entity, analyze the content to identify negative sentiment and automatically post a response to the message of the negative content.

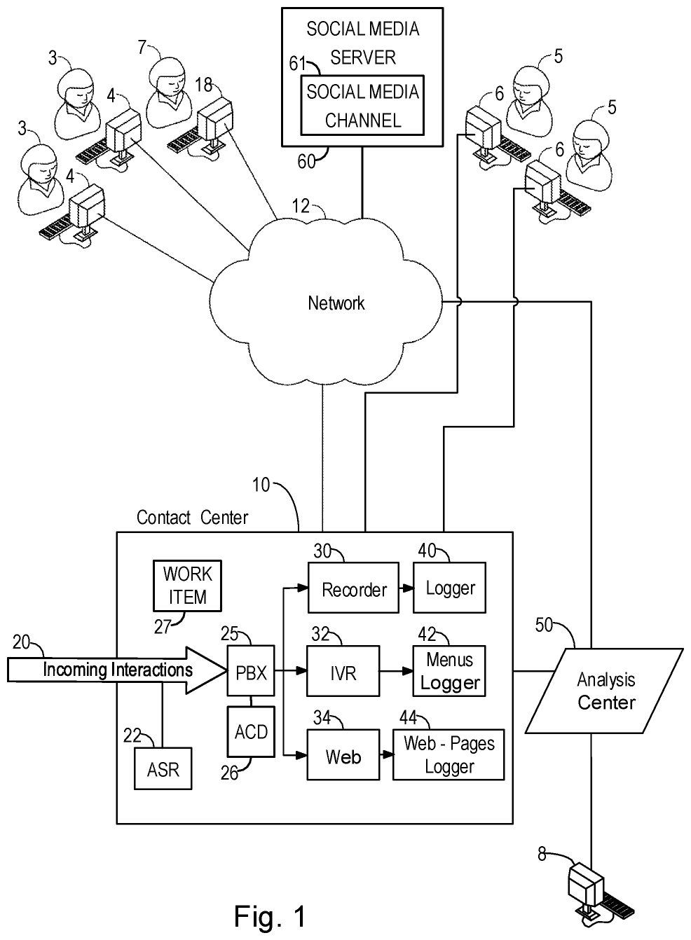

FIG. 1 is a block diagram of a system for automatically responding to negative content in social networks, according to embodiments of the present invention. While FIG. 1 shows a such a system in the context of a contact center, embodiments of the invention may be used in other contexts. Contact center 10 may include any facility or system server suitable for receiving and recording electronic communications from customers. Such contact communications may include, for example, telephone calls, facsimile transmissions, e-mails, web interactions, voice over IP (“VoIP”), video, etc. Various specific types of communications contemplated through one or more of these channels may include, without limitation, email, SMS data (e.g., text), tweet, instant message, web-form submission, smartphone applications, social media data, and web content data (including but not limited to internet survey data, blog data, microblog data, discussion forum data, and chat data), etc. In some embodiments, the communications may include contact tasks, such as taking an order, making a sale, responding to a complaint, etc. In various aspects, real-time communication, such as voice, video, or both, may be included. It is contemplated that these communications may be transmitted by and through any type of telecommunication device and over any medium suitable for carrying data (e.g., over network 12). For example, the communications may be transmitted by or through telephone lines, cable, or wireless communications.

Incoming interactions 20, e.g., conversations, telephone calls, interactive voice response (IVR) interactions, etc., among people 3, e.g., customers or clients, and agents 5 may enter a contact center 10 and be routed for example by a private branch exchange (PBX) 25 and/or automatic call distributer (ACD) 26 or other equipment to relevant systems, such as IVR block or processor 32, Internet sessions or web block 34 and voice interactions block or recorder 30. People 3 may operate external user equipment 4 to communicate with agents 5 via contact center 10; and agents 5 may operate agent terminals 6 for that communication and other purposes. Agent terminals 6 may be configured to present work items 27 and other content to agents, according to embodiments of the invention. The work items 27 may be presented to the agents on a display, as part of a graphical user interface (GUI). Incoming interactions 20 may be pre-processed and may enter the system as text data, or may be converted to text via automatic speech recognition (ASR) module 22. User terminals 8 may be operated for example, by a supervisors and/or managers. User terminals 8 may provide data regarding negative content to supervisors and/or managers, according to embodiments of the invention.

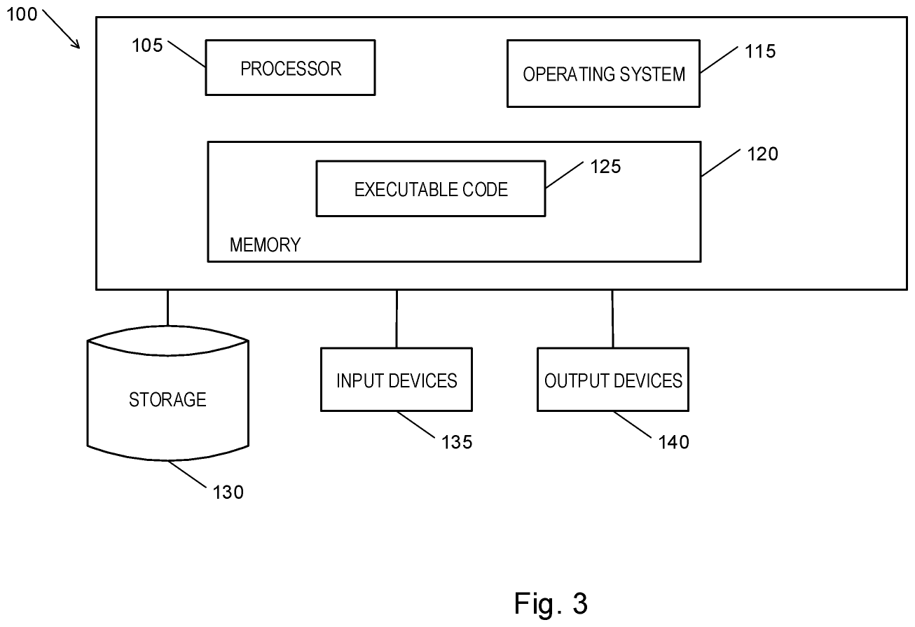

User equipment 4, agent terminals 6, user terminals 8 and publisher computer 18 may include computing or telecommunications devices such as personal computers or other desktop computers, conventional telephones, cellular telephones, portable or tablet computers, smart or dumb terminals, etc., and may include some or all of the components such as a processor shown in FIG. 3.

Interaction data or documents may be stored, e.g., in files and/or databases, e.g., in storage 130. For example logger 40, menus logger 42, and web-page logger 44 may record information related to interactions, such as the content or substance of interactions (e.g. recordings and/or transcripts of telephone calls) and metadata (e.g. telephone numbers used, customer identification (ID), etc.). In the case that documents other than interactions are used, other databases may be used. The data from contact center 10 may be output, sent or exported to an analysis center 50, which may be part of contact center 10, or external to and/or remotely located from contact center 10.

One or more networks 12 may connect equipment or modules not physically co-located, for example connecting external user equipment 4 to contact center 10, and contact center 10 to analysis center 50. Networks 12 may include for example telephone networks, e.g., such as a public switched telephone network (PSTN), the Internet, or other networks. While in FIG. 1 contact center 10 is shown passing data to analysis center 50, these modules may communicate via a network such as networks 12. Networks 12 may further connect publisher computer 18, user equipment 4 and analysis center 50 to social media server 60.

Web block 34 may support web interactions over the Internet (e.g., operate web pages which may be executed in part on user equipment), IVR block 32 may provide menus and other information to customers 3 and for obtaining selections and other information from customers 3, and recorder 34 may process or record voice sessions with customers 3. It may be appreciated that contact center 10 presented in FIG. 1 is not limiting and may include any blocks and infrastructure needed to handle voice, text, e.g., short message service (SMS), WhatsApp messages, chats, etc., video and any type of interaction with customers 3.

ACD 26 may distribute incoming interactions 20 or tasks to agents 5 via agent terminals 6. Generally, ACD 26 may be a part of a switching system designed to receive incoming interactions 20 and queue them. In addition, ACD 26 may distribute the incoming interactions 20 to agents 5 or specific groups of agents 5 typically according to a prearranged scheme. In one embodiment, ACD 26 may be integrated with PBX switch 25, and may direct incoming interactions 20 to one of a plurality of agent terminals 6.

Generally, ACD 26 may receive incoming interactions 20 that may be handled by one of agents 5 at contact center 10. ACD 26 may connect an incoming interaction 20 to an appropriate agent 5 if the agent 5 is available. If the agent 5 is not available, the incoming interaction 20 may be held by ACD 26 until the agent 5 becomes available. While an incoming interaction 20 is waiting for an agent 5, ACD 26 may collect data of the incoming interaction 20 or perform other automated processes. Once agent 5 is available, ACD 26 may route the incoming interaction 20 to agent 5.

In one embodiment, ACD 26 may be configured to perform skill-based routing, which may refer to routing incoming interactions 20 based on matching the skills required for handling the incoming interactions 20 and the skillset of agents 5. This may ensure that incoming interactions 20 may go to agents 5 with the correct skills to ensure a better contact experience. Skill-based routing may consider the unique skills of individual agents 5 and the preferences of individual customers 3 to route incoming interactions 20 to the most qualified or most appropriate agent 5.

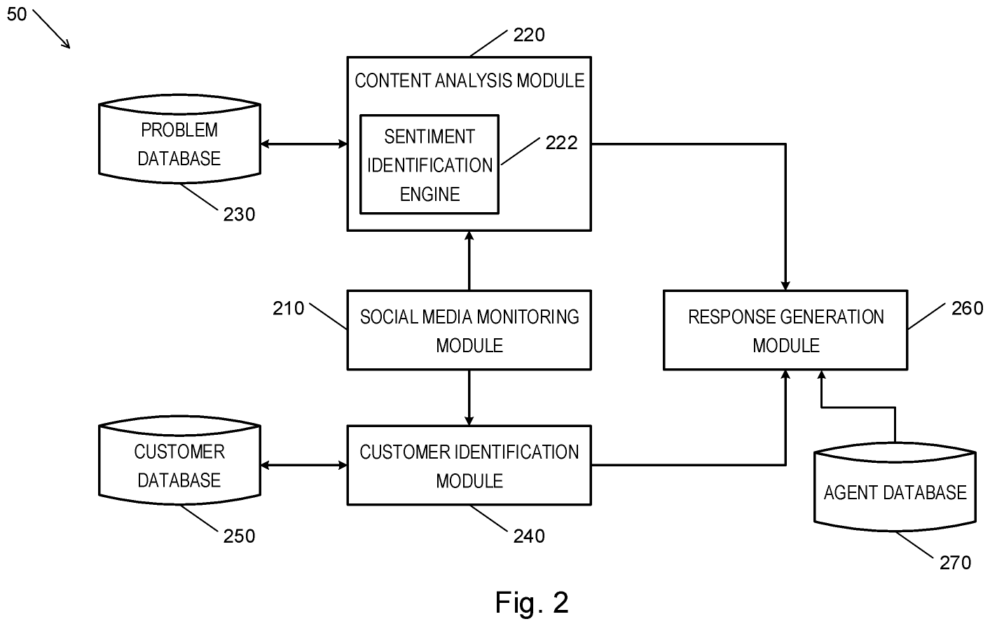

When an incoming interaction 20 is received at ACD 26, the customer 3 may first be identified (e.g., via the contact's touch-tone entry of an account number or identification number, caller ID, or identification number associated with the customer 3), and a contact profile may be retrieved from a database (e.g., customer database 250 depicted in FIG. 2). Before connecting the incoming interaction 20, customer database 250 may typically be queried to determine the customer preferences. Agent information may be stored in agent database 270 (depicted in FIG. 2) that may also be queried to determine which skills of the agents 5 match the preferences of the customer 3. Once a suitable agent 5 is identified, ACD 26 may route incoming interaction 20 to the appropriate agent 5 via the appropriate agent terminal 6.

Social media channel 61 may be hosted by social media or other forum server 60. Publisher 7 may publish content, e.g., posts, messages, etc. on social media channel 61, via publisher computer 18 and social media server 60. Publisher 7 may have a username that identifies publisher 7 on social media channel 61. Publisher 7 may further have an account on social media channel 61 that may include other identifying details, referred to herein as attributes, of publisher 7 such as: first name, last name, address, phone number, email address, etc. Social media or other forum server 60 may be or may include a computing device such as computing device 100 shown in FIG. 3. Publisher 7 may or may not be a customer or client such as customer 3 that may communicate with contact center 10.

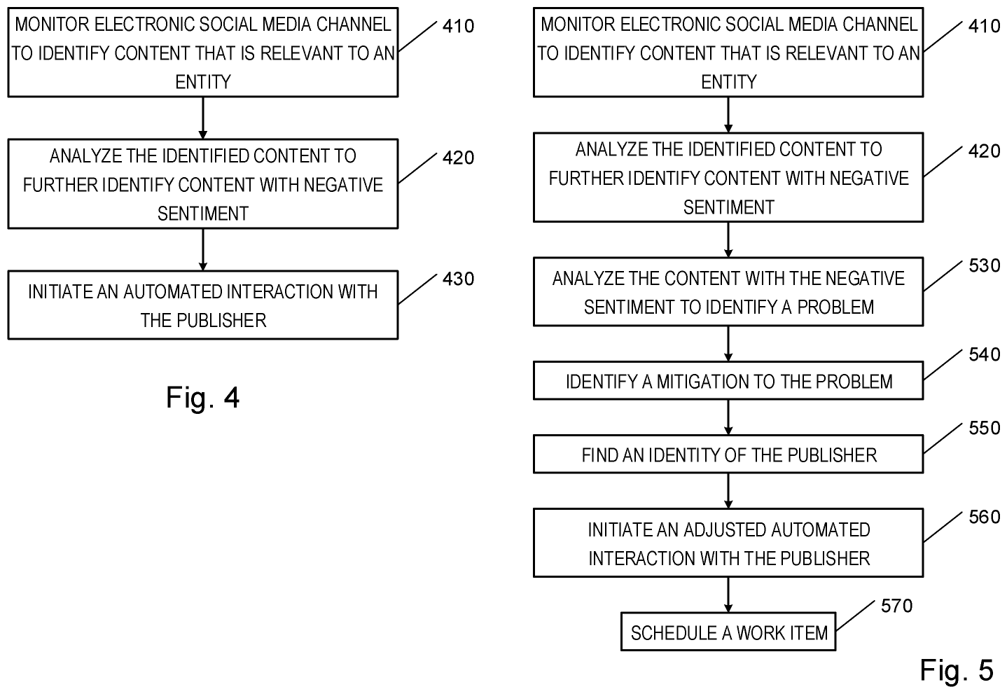

Analysis center 50 may perform functions such as those shown in FIGS. 4 and 5, and may be implemented as software code and/or hardware for analyzing content on social media channels and automatically responding to negative content in social networks as disclosed herein. Analysis center 50 may communicate with contact center 10, and one or more agent terminals 6 and user terminals 8 to, for example, schedule work items 27 and present the scheduled work items 27 to agents. Analysis center 50 may further communicate with social media channels 61, to obtain content from the social media channels 61 and to post massages and replies on the social media channels 61, as disclosed herein.

Work items 27 may include digital notes to agents 5 to perform certain job functions, and these work items 27 may, in certain embodiments, show up at agent terminal 6, e.g., in an inbox of the agent 5, in a task list or on the display of agent terminal 6. These work items 27 may show up on agent terminals 6 as scheduled tasks in a daily agenda of an agent 5. In the context of this disclosure, the process of adding a work item 27 to an agent's inbox or daily agenda is referred to as “scheduling” a work item 27.

FIG. 2 is a high-level block diagram of an analysis center 50, according to embodiments of the present invention. The block diagram depicted in FIG. 2 is an example and other designs may be used. Analysis center 50 may include computing devices such as personal computers, desktop computers, servers, etc., and may include some or all of the components of a computing device 100 such as a processor shown in FIG. 3. Analysis center 50 may be local to contact center 10 or distributed (e.g., accessible over network 12, and may be at least partially implemented on a remote computing device, e.g., in the cloud). Each of social media monitoring module 210, content analysis module 220, customer identification module 240, and response generation module 260 may be or may include a software module or software code, executable by computing device 100 and/or may include dedicated hardware. Each of database of known problems 230, customer database 250, and agent database 270 may be implemented in storage 130.

According to embodiments of the invention, social media monitoring module 210 may automatically monitor one or more electronic social media channels 61 (depicted in FIG. 1) to identify content that is relevant to an entity, e.g., a company or organization. According to some embodiments, monitoring an electronic social media channel 61 may include finding one or more posts on the social media channel 61 that includes content that is related or relevant to the entity, e.g. describes or mentions the entity or a product or service produced by or associated with the entity. According to some embodiments, social media monitoring module 210 may obtain, e.g., from a user, a selection or identification of which social media channels 61 or other fora to monitor. For example, the monitored social media channels 61 may be one or more from Facebook®, Twitter®, LinkedIn®, or another social network or forum, e.g. Yelp reviews. Social media monitoring module 210 may search the publicly available feed of the selected social channels 61, for example by utilizing application programming interfaces (APIs) of the selected social channels 61 to read content that is posted to those selected social channels 61. The search may include filtering or searching for content on the selected social channels 61 to identify all publicly accessible content related or relevant to the entity. This filtering may be achieved, for example, by finding posts targeting, tagging or creating a link (e.g., using a predefined symbol such as @ followed by the account name) to a specific social media account owned by the entity, by finding posts that contain one or more specific social media tags, or by finding posts that mention products or services associated with the entity. For example, social media monitoring module 210 may, through the use of the Twitter APIs, read all messages that “@-mention” (e.g., posts that create a link to) the Twitter account of the entity or include strings matching the entity or products or services of the entity. Additionally or alternatively, social media monitoring module 210 may obtain a list of hashtags that are identified as being relevant, e.g., from a user or from other sources. Using that same API, social media monitoring module 210 may read all messages or posts that have a hashtag that is identified as being relevant. As another example, social media monitoring module 210 may, through the use of the Facebook APIs, read all posts that “tag” or “@-mention” the entity's Facebook page. Methods other than reviewing tags or hashtags may be used, e.g., keyword search.

Once a relevant social media post is found or identified, social media monitoring module 210 may extract more relevant content by searching for posts that are associated or related to the first identified post, e.g., related posts by the same publisher 7, responses to the first posts and to the related posts, etc. Social media monitoring module 210 may extract the content of the first social media post, as well as content from all other identified related posts.

For example, social media monitoring module 210 may extract the first social media post using the API of a specific social media channel. Social media monitoring module 210 may retrieve the main social media post content, as well as related posts by the same author or publisher 7 through topic links on the social media channel provided by the channel API, or similar posts by the same author or publisher 7 within a certain period of time. As a specific example, using the Twitter API social media monitoring module 210 may retrieve the initial “tweet” that contained a specific hashtag, as well as all subsequent tweets that were posted as replies, whether or not they also contained that same hashtag.

According to embodiments of the invention, content analysis module 220 may analyze the extracted content, e.g., the first post, the related posts and the responses, to identify a sentiment expressed in the extracted content, and more specifically, to identify negative sentiment or a complaint. Content analysis module 220 may further identify the publisher 7 that published the content with negative sentiment in social media channel 61, e.g., the username or account that is associated with the post containing the negative content. For example, content analysis module 220 may categorize the content found by social media monitoring module 210 as negative, e.g., content that is relevant to the entity and includes negative sentiment, and positive or neutral, e.g., content that is relevant to the entity and does not include negative sentiment. For example, content analysis module 220 may extract keywords e.g., by removing common language elements (e.g., articles, conjunctions, prepositions), from the identified content and provide the keywords to a sentiment identification engine 222, e.g., a machine learning (ML) model that has been trained to identify sentiment from the keywords and a confidence level of the identified sentiment. Using only keywords for analyzing the sentiment in the extracted content may enable more accurate sentiment recognition despite the difficult syntax often employed in social media contexts (e.g., word contractions, hash tags and slang), comparing to using the entire text.

In one embodiment, the ML model may be a neural network (NN) model based on Google® TensorFlow®, or other ML model, that is trained by providing the NN model with a plurality of labeled samples, e.g., 10,000 or more tweets randomly captured from the Twitter stream using the Twitter API. Those tweets may be categorized and labeled as positive or negative (e.g., “happy” or “unhappy”, respectively) by manual inspection. The labeled tweets may be presented to TensorFlow using its supervised training API one at a time, including the predetermined categorization or labelling as the required output, such that TensorFlow can build an ML or NN model that may infer the sentiment from the tweet content. Once TensorFlow has trained the ML or NN model by the labeled tweets, a model file may be created that includes the trained model. In the inference stage, the trained model can be presented a random tweet and use the trained model to output a positive or negative determination, and a confidence score in that determination. Note that the training may be performed once, and then the model may be used repeatedly by sentiment identification engine 222. However, in specific implementations, the model may be updated by randomly sampling content over time, manually categorizing it, and providing it to TensorFlow as additional training data. This same training procedure may be repeated for each specific social media channel such that the training model for one channel can be separate from another channel, given that the style of communication by users of one social media channel may be different from other channels.

According to some embodiments, content analysis module 220 may further analyze the content with the negative sentiment, e.g., the content that was categorized by sentiment identification engine 222 as negative or “unhappy” with a confidence rating that satisfies a threshold. For example, content analysis module 220 may further analyze the content with the negative sentiment to identify a problem, e.g., a specific complaint or issue that is raised by the client in the negative post. Content analysis module 220 may analyze the content with the negative sentiment to identify a problem by extracting keywords from the content with the negative sentiment and using the keywords as search terms to query a database of known problems 130, to identify the problem. For example, the same keywords used by other methods may be used to identify the problem, such as natural language processing (NLP), classifiers and text analysis.

For example, the keywords extracted from the content that was categorized as negative, e.g., the same keywords extracted by sentiment identification engine 222 or other keywords, may be used as search terms to query a database of known problems 230, using techniques common in the art. In some embodiments, the database of known problems 230 may be maintained by the entity through its ongoing relationships with clients, as well as through the entity's internal corporate knowledge, and the maintenance of database of known problems 230 is outside the scope of this present invention. The results of the keyword search may retrieve zero or more database records of problem categorizations and associated mitigations or resolutions. A mitigation or resolution may be, e.g. a solution to or advice in dealing with the problem identified in the posting. For example, a social media post could be reduced to the keywords “phone black screen”. The keyword search could then return the category “software problem” with a mitigation that contains a hyperlink to an article on how to reboot a smart phone.

According to embodiments of the invention, customer identification module 240 may attempt to identify or find an identity of the publisher of the post with the negative content in a customer database of the entity or organization. For example, customer identification module 240 may extract attributes from a profile of the publisher of the negative post and associate each attribute with an importance level, select at least one of the attributes based on the importance level of the attributes, use the selected attributes as keywords for searching a customer database 250 for an identity of the publisher, and in case that the identity of the publisher is found in customer database 250, associate a confidence score to the found identity of the publisher, where the confidence score is indicative of chances that the identification is correct. Customer database 250 may include details or attributes of customers such as customer name, address, contact details, preferred communication channels, interaction history and all other relevant details, as desirable by the entity keeping customer database 250. In some embodiments, customer database 250 may be maintained by the entity through its ongoing relationships with clients and customers, as well as through its internal corporate knowledge, and the maintenance of customer database 250 is outside the scope of this present invention.

For example, customer identification module 240 may obtain a public profile of the publisher of the negative social media post (e.g., a social media post containing the negative content) using APIs of the specific social media channel being monitored. This public profile may include, for example, one or more of attributes such as: first name, last name, email address, hometown, home province or state, home country, telephone number, etc. Customer identification module 240 may rank the attributes from the profile according to importance, and/or associate the attributes with a weight. In some embodiments, the ranking and/or weighting of the attributes may be defined by a user e.g., a human operator. The ranking and weighting may be a measure of the attribute importance, e.g., ranking and weighting may be indicative of the ability to correctly identify or find the identity of the publisher based on this attribute. In some embodiments, the ranks and/or weights of the attributes may be in a scale, e.g., ranging from 0 to 1 or 0 to 100, where a higher number may indicate higher importance of the attribute. For example, an attribute that is maintained in customer database 250 of a specific entity or organization, and specifically an attribute that is unique to a customer, may have high rank and/or weight since this attribute may be used to identify or find the identity of the publisher with high confidence. For example, a customer identified solely by last name and hometown may be ranked and/or weighted such that a match will have a lower confidence score than a customer identified by email address and hometown, if the email address is ranked and weighted higher.

Customer identification module 240 may use some or all of the attributes retrieved from the social media profile as a key to search customer database 250. In some embodiments all the retrieved attributes may be used. In some embodiments, only a subgroup of attributes may be selected and used for the search, e.g., based on the ranks or weights. For example, a subgroup of attributes having the higher ranks or weights comparing to other attributes may be selected, thus higher-ranked or higher-weighted attributes may take precedence over a lower-ranked attributes or lower-weighted attributes. Similarly, in some embodiments, a higher combination of attribute weights or ranks may take precedence over a lower combination of attribute weights or ranks. In one embodiment, rows (e.g., customer identities) returned from each query may be retained as distinct sets, and the results in each set may be assigned the specified weighting for the attribute used by that set. The sets may then be combined into a unified set such that, where a customer row appears in multiple sets, the weightings are added together. The unified set may then be sorted by the combined weighting, and a single customer identity with the highest weighting may be selected. Customer identification module 240 may associate or determine a confidence score in the resultant customer identity by comparing the weighted result to one or more threshold values. The confidence score may have multiple threshold values to allow for a degree of confidence (“extremely high”, “very high”, “high”, . . . ) to be assigned.

According to embodiments of the invention, response generation module 260 may initiate or start an automated (e.g. via an autonomous agent or “bot”) interaction with the publisher of the negative content, e.g., transmitting or posting an electronic notice (e.g. a reply or response to the post, on social media channel 61 or other site where the post exists, with the negative content). The nature and type of the automated interaction may vary according to preferences of the organization or entity that performs the method for automatically responding to negative content according to embodiments of the invention. The nature and type of the automated interaction may further vary according to the extracted information regarding the negative content, e.g., the specific problem, if such problem could be identified with high confidence, and the identity of the publisher, if the identity could be found or identified with high confidence, etc. Negative content may include a social media post, product review, or other online communication which is negative, or criticizes or insults a product, service, or organization.

For example, initiating an automated interaction, e.g., via an autonomous agent or “bot”, with the publisher of the negative content may include posting an automatic reply to the post that was identified or categorized as including negative sentiment in the electronic social media channel. Additionally or alternatively, an automatic phone call to the publisher of the negative content may be initiated. According to embodiments of the invention, the type and content of the initiated automated interaction may depend on whether a specific problem was identified (e.g., by content analysis module 220) and on whether the identity of the publisher was found or identified (e.g., by customer identification module 240).

For example, if no problem could be identified and the identity of the customer could not be identified, then a generic response may be automatically published in response to the post with the negative content by response generation module 260. The generic response may include some boilerplate language expressing for example empathy, willingness to resolve the problem and contact details of the entity. The response may be formatted to be suitable for the particular social media channel. Additionally or alternatively, a work item 27 may be scheduled in contact center 10 for an agent 5 skilled in the particular social media channel where the negative content has been identified. The work item 27 may include a task to respond to the post with the negative content, the relevant details that the agent 5 may need and include a reference or a hyperlink to the post including the negative content.

If, however, a specific problem has been identified, response generation module 260 may adjust the initiated interaction according to the identified problem. For example, the mitigation associated with the specific problem, e.g., the mitigation retrieved from problem database 230, may be included in the initiated interaction. If a work item 27 for an agent is scheduled, the work item 27 may include, in addition to the reference or a hyperlink to the post including the negative content, a description of the problem and an identified mitigation, e.g., a mitigation retrieved from problem database 230.

Similarly, if the identity of the publisher is found, e.g., in the customer database 250, then the initiated interaction may be adjusted according to the identity of publisher 7. For example, in case the identity of publisher 7 is found, the content of the automatic response may include personalized data and a work item 27 may be generated for an agent 5 of contact center 10 to proactively contact the identified publisher 7.

According to some embodiments, the work item 27 may be directed to an agent that is associated with skills relevant to at least one of the identified problem, the publisher and the communication channel. For example, response generation module 260 may select from an agent database 270, e.g., a database that associates skills with agents, an agent that is associated with skills relevant to at least one of the problem, the publisher and the communication channel. For example, a work item 27 that is categorized as a “software problem”, and where the customer expressed their dissatisfaction on Twitter in the Spanish language, would be routed to an agent that spoke Spanish, was skilled in the use of Twitter, and was able to support software-related problems.

In case publisher 7 has been identified with high confidence to be a customer (such as customer 3), e.g., in customer database 250, the work item 27 may include other contextual information about the publisher 7 retrieved from the customer record in customer database 250. Examples of such context may include, but is not limited to: using the customer's proper name, instead of their social media “handle”; how long the publisher 7 has been a customer; previous problem history; or their recent purchase history. When the work item 27 is routed to an appropriate agent 5 by response generation module 260, this context may allow an agent 5 to have a more personalized engagement with the publisher 7, ideally resolving their issue in a friendlier way that increases the publisher 7's overall satisfaction.

In case both the problem and the publisher 7 has been identified with high confidence, then in one embodiment of the invention, a pre-formatted, automated reply may be provided based on the mitigations that were identified, a personalized greeting may be used, the problem description may be echoed back with additional customer-specific context, suggested mitigations may be offered, an offer to schedule a telephone callback may be provided, and then the reply may be formatted in a way that is suitable for the particular social media channel. The reply may be automatically generated and published as a reply to the post including the negative sentiment.

If the publisher 7's issue cannot be easily resolved through a social media channel, then where a publisher 7 has been identified in customer database 250 with high confidence, and that identity include a telephone number of publisher 7, the automatic response may offer to schedule a follow-up phone call with publisher 7 to discuss their issue. In one embodiment of the invention, the scheduling may be performed automatically by ACD 26 or other components of contact center 10. In another embodiment, a hyperlink may be provided to publisher 7 through the social media channel. This hyperlink may direct the publisher 7 to the contact center 10.

The scheduling of a follow-up call with publisher 7 may be performed, for example, by ACD 26 of contact center 10. The follow-up call may be scheduled, queued, and routed to an agent 5 that is skilled in phone contacts including, but not limited to, matching the language preference of publisher 7, using the skill-based routing process. The follow-up call may be provided to the selected agent as a work item 27 including a task to call publisher 7 of the post with the negative content. Note that the agent 5 selected for performing the follow-up phone call may or may not be the same agent 5 that performed the social media interaction. The work item 27 with the scheduled follow-up call event may include the history of the social media interaction, and the details of the previous social media engagement, thus allowing the agent 5 receiving the work item 27 to have a more intimate engagement with publisher 7, ideally resolving the customer issue in a way that maximizes publisher 7 satisfaction.

FIG. 3 is a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140. Each of modules and equipment such as contact center 10, ASR module 22 PBX 25, IVR block 32, voice interactions block or recorder 30, menus logger 42, connect API 34, analysis center 50, external user equipment 4, agent terminals 6, user terminals 8 publisher computer 18, social media server 60, and other modules discussed herein may be or include a computing device such as included in FIG. 3, although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long term memory unit, or other suitable memory units or storage units. Memory 120 may be or may include a plurality of possibly different memory units. Memory 120 may store for example, instructions (e.g., code 125) to carry out a method as disclosed herein, and/or data such as queries, documents, interactions, etc.

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used and may be connected to a network and used as a system. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as documents or interactions may be stored in a storage 130 and may be loaded from storage 130 into a memory 120 where it may be processed by controller 105. In some embodiments, each of database of known problems 230, customer database 250, and agent database 270 may be implemented in storage 130. In some embodiments, some of the components shown in FIG. 3 may be omitted. In some embodiments, at leases some of the components shown in FIG. 3 may be remote, e.g., implemented on a “cloud” and accessible over network 12.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 4 is a flowchart of a method for automatically transmitting an electronic notice to a publisher of negative content, according to embodiments of the present invention. While in some embodiments the operations of FIG. 4 are carried out using systems as shown in FIGS. 1, 2 and 3, e.g., by analysis center 50. In other embodiments other systems and equipment can be used.

In operation 410, a processor may monitor, by an automated process executed by the processor (e.g., processor 105 depicted in FIG. 3), at least one electronic social media channel (e.g., social media channel 61 depicted in FIG. 1) to identify content that is relevant to an entity. According to some embodiments, monitoring an electronic social media channel may include finding one or more posts on the social media channel that include content that is relevant to the entity. For example, the processor may monitor an electronic social media channel by searching the publicly available feed of the social channel, for example by utilizing APIs of the social channel to read content that is posted to this social channel. The search may include filtering content on the social channel to identify all publicly accessible content relevant to the entity. This filtering may be achieved, for example, by finding posts targeting a specific social media account owned by the entity, or by finding posts that contain one or more specific social media tags. Once a post is found, the processor may extract more relevant content by searching for posts that are associated or related to the first identified post, e.g., related posts by the same publisher, responses to the first posts and to the related posts, etc.

In operation 420, the processor may analyze the identified content, e.g., the first posts, the related posts and the responses, to further identify content with negative sentiment, and the publisher of the content with the negative sentiment. For example, the processor may extract keywords e.g., by removing common language elements (e.g., articles, conjunctions, prepositions), from the identified content and provide the keywords to a sentiment identification engine, e.g., a machine learning (ML) model that has been trained to identify sentiment from the keywords and a confidence level of the identified sentiment. Other methods may be used to identify sentiment in the extracted content, e.g., natural language processing (NLP) and text analysis. The processor may further identify the publisher of the content with negative sentiment, e.g., a username associated with the negative content.

In operation 430, the processor may initiate an automated interaction with the publisher of the negative content. For example, the processor may automatically publish in the social media channel an electronic notice including a response or a reply to the post with the negative content.

FIG. 5 is a flowchart of a second method for automatically transmitting an electronic notice to a publisher of negative content, according to embodiments of the present invention. While in some embodiments the operations of FIG. 5 are carried out using systems as shown in FIGS. 1, 2 and 3, in other embodiments other systems and equipment can be used. Operations 410 and 420 are identical to operations with the same reference numerals in FIG. 4, and will not be described again.

In operation 530, the processor may analyze the content with the negative sentiment to identify a problem or a specific complaint. The processor may analyze the content with the negative sentiment using any applicable method, including, but not limited to NLP, text analysis etc. In some embodiments, the processor may extract keywords from the content with the negative sentiment and use the keywords as search terms to query a database of known problems to identify the problem. In operation 540, the processor may find mitigations for the identified problem, for example, the database of known problems may include mitigations to the problems, e.g., a mitigation may be associated with problems. Thus, once a problem is found in the problem database, the associated mitigation may be retrieved.

In operation 550, the processor may find an identity of the publisher in a customer database of the entity, or the identity of the publisher may be otherwise identified, e.g., in other databases. For example, the processor may identify the publisher by extracting attributes from the profile of the publisher and associating each attribute with an importance level. The processor may use the attributes, or a subset of attributes with high importance (e.g., attributes with importance level above a threshold or the attributes with the highest importance level), as keywords for searching the customer database for an identity of the publisher. The processor may assign a confidence score, indicative of chances that the identification is correct, to the retrieved identity, e.g., based on the importance level of the attributes used for finding the identity of the publisher.

In operation 550, the processor may initiate an automated interaction with the publisher. The processor may adjust the automated interaction depending on the results of operations 530-550. For example, if no problem could be identified and the identity of the customer could not be identified, then the processor may post a generic response in response to the post with the negative content. If, however, a specific problem has been identified, e.g., in operation 530, the processor may adjust the initiated interaction according to the identified problem, e.g., by including a specific reference to the identified problem. If a mitigation was found, e.g., in operation 540, then the mitigation associated with the specific problem may be included in the initiated interaction. Similarly, if the identity of the publisher is found, e.g., in operation 550, then the initiated interaction may be adjusted according to the identity of the publisher e.g., the content of the automatic response may include personalized data.

If the identity of the publisher was found, e.g., in operation 550, then in operation 570, the processor may schedule a work item for a contact center agent. The processor may further adjust the work item depending on the results of operations 530. For example, if no problem could be identified the work item may include the identity of the publisher and the original text of the post. If, however, a specific problem has been identified, e.g., in operation 530, the processor may adjust the work item according to the identified problem, e.g., by including a specific reference to the identified problem. If a mitigation was found, e.g., in operation 540, then the mitigation associated with the specific problem may be included in the work item. According to some embodiments, the work item may be directed to an agent that is associated with skills relevant to at least one of the identified problem, the publisher and the communication channel.

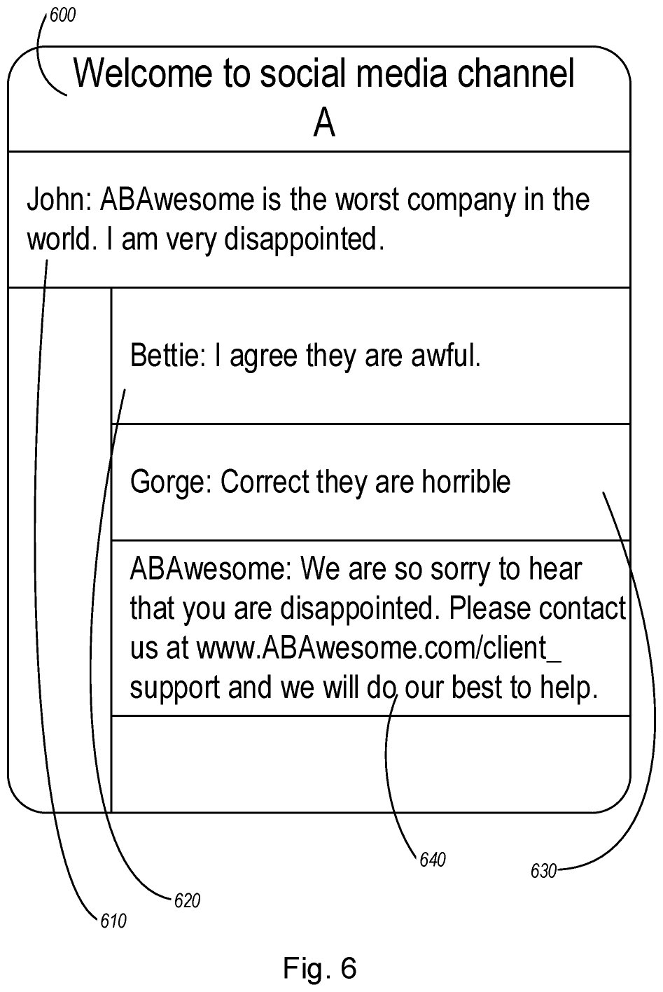

FIG. 6 is an example of a screenshot 600 of a social media channel, according to embodiments of the invention. In this example, a publisher called John publishes a negative post 610, or a post with negative sentiment regarding a company called ABAwesome. According to embodiments of the invention, posts published in media channel 600 may be regularly monitored, e.g., by social media monitoring module 210. Post 610 may be identified as relating to the entity ABAwesome since it includes the word “ABAwesome”. Once post 610 is identified as relating to ABAwesome, related posts, such as replies 620 and 630 may also be identified as relating to ABAwesome. Thus, the content of main post 610 and related posts 620 and 630 may be extracted. Next, the extracted content, e.g., content extracted from posts 610-630, may be analyzed to identify a sentiment expressed in the extracted content. For example, keywords such as, worst, company, world, disappointed, agree, awful and horrible may be extracted and provided to an ML model trained to identify sentiment. The model may identify negative sentiment in the main post and in the related posts. Next, the same keywords may be used to try to identify a problem or specific complaint, e.g., by searching a problem database. In this case no specific problem could be identified. The identity of the publisher John, could not be identified as well. Therefore, according to embodiments of the invention, a reply 640, including generic language may be automatically posted.

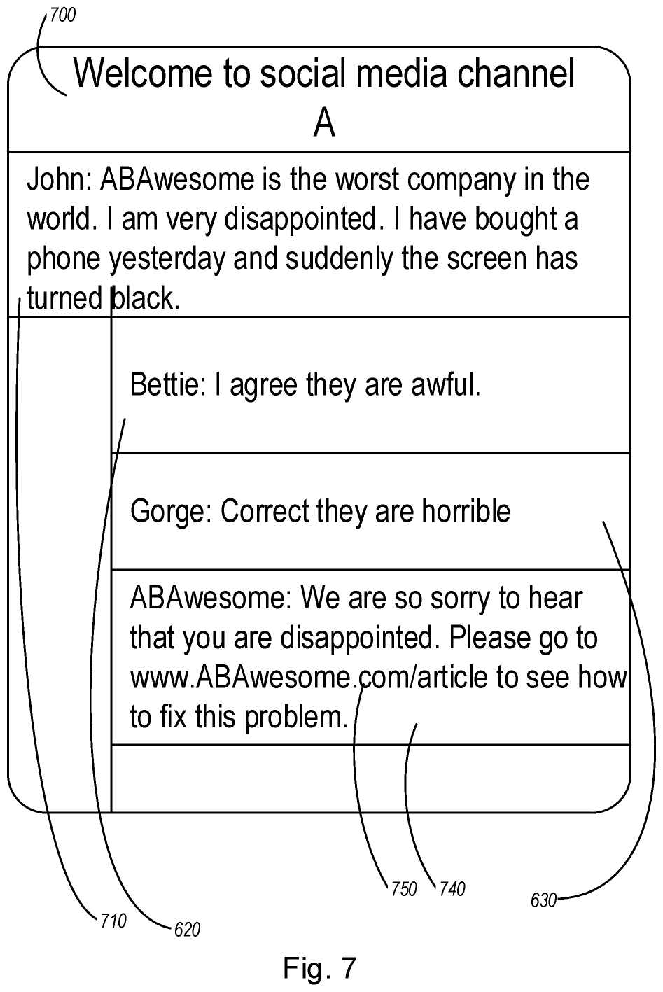

FIG. 7 is a second example of a screenshot 700 of a social media channel, according to embodiments of the invention. In this example, the publisher called John publishes a negative post 710, or a post with negative sentiment regarding a company called ABAwesome. Similarly to post 610, post 710, as well as replies 620 and 630 may be identified as relating to the entity ABAwesome and as including negative sentiment. However, in this example, a specific problem (a software problem) and a mitigation (a hyperlink to an article on how to reboot a smart phone) are identified, e.g., by searching a problem database. The software problem and mitigation could be identified due to the keywords “phone black screen”. Thus, the automatic reply 740 is adjusted to include the mitigation 750. In case the identity of the publisher is identified as well, a work item may be scheduled for an agent of ABAwesome with relevant skills to proactively contact John.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for automatically transmitting an electronic notice to a publisher of negative content, the method comprising, using a processor:
monitoring, by an automated process executed by the processor, at least one electronic social media channel to identify content that is relevant to an entity;
analyzing, by the automated process, the identified content to identify content with negative sentiment, and the publisher of the content with the negative sentiment; and
initiating, by the automated process, an automated interaction with the publisher.

2. The method of claim 1, wherein initiating the interaction comprises at least one of: posting an automatic reply to a message in the electronic social media channel that includes the content with the negative sentiment or initiating an automatic phone call.

3. The method of claim 1, comprising:
analyzing the content with the negative sentiment to identify a problem; and
adjusting the initiated interaction according to the identified problem.

4. The method of claim 3, wherein analyzing the content with the negative sentiment to identify the problem comprises:
extracting keywords from the content with the negative sentiment; and
using the keywords as search terms to query a database of known problems to identify the problem.

5. The method of claim 4, wherein the database of known problems comprises mitigations to the problems, wherein adjusting the initiated interaction comprises:
retrieving from the database of known problems a mitigation that is associated with the identified problem; and
including the mitigation in a response to a message in the social media channel that includes the content with the negative sentiment.

6. The method of claim 1, comprising:
finding an identity of the publisher in a customer database of the entity; and
adjusting the initiated interaction according to the identity of the publisher.

7. The method of claim 6, wherein finding the identity of the publisher comprises:
extracting attributes from a profile of the publisher, wherein each attribute is associated with an importance level;
selecting at least one of the attributes based on the importance level of the attributes;
using the selected attributes as keywords for searching the customer database for an identity of the publisher; and
associating a confidence score to the identity of the publisher, wherein the confidence score is indicative of chances that the identification is correct.

8. The method of claim 1, wherein monitoring the at least one social media channel comprises accessing the publicly accessible content that includes a tag or a hashtag relating to the entity.

9. The method of claim 1, wherein monitoring the at least one social media channel comprises:
finding a first post on the at least one social media channel that includes at least part of the content that is relevant to the entity;
finding related posts by the same publisher;
finding responses to the first post and to the related posts;
extracting keywords from the first post, the related posts and the responses; and
providing the keywords to a machine learning (ML) model that has been trained to identify sentiment from the keywords and a confidence level of the identified sentiment.

10. The method of claim 1, comprising:
analyzing, by the automated process, the content with the negative sentiment to identify a problem;
retrieving, by the automated process, from a client database, a communication channel and contact information of the publisher;
retrieving, by the automated process, from a database of known problems a mitigation that is associated with the identified problem; and
scheduling, by the automated process, a work item for an agent, wherein the work item comprises the communication channel, the contact information and the mitigation.

11. The method of claim 10, comprising:
selecting, by the automated process, from a database of agents and associated skills, the agent that is associated with skills relevant to at least one of the problem, the publisher and the communication channel.

12. A method for automatically responding to negative content, the method comprising:
automatically monitoring, by a processor, an electronic social media platform to find publicly available content that is related to a company;
categorizing, by the processor, the publicly available content that is related to the company to as negative or neutral; and
posting, by the processor, an automatic reply to at least one post that includes the content that is categorized as negative.

13. A system for automatically transmitting an electronic notice to a publisher of negative content, the system comprising:
a memory and;
a processor configured to:
monitor at least one electronic social media channel to identify content that is relevant to an entity;
analyze the identified content to identify content with negative sentiment, and the publisher of the content with the negative sentiment; and
initiate an automated interaction with the publisher.

14. The system of claim 13, wherein the processor is configured to initiate the interaction by at least one of: posting an automatic reply to a message in the electronic social media channel that includes the content with the negative sentiment or initiating an automatic phone call.

15. The system of claim 13, wherein the processor is configured to:
analyze the content with the negative sentiment to identify a problem; and
adjust the initiated interaction according to the identified problem.

16. The system of claim 15, wherein the processor is configured to analyze the content with the negative sentiment and adjust the initiated interaction by:
extracting keywords from the content with the negative sentiment;
using the keywords as search terms to query a database of known problems to identify the problem, wherein the database of known problems comprises known problems and associated mitigations;
retrieving from the database of known problems a mitigation that is associated with the identified problem; and
including the mitigation in a response to a message in the social media channel that includes the content with the negative sentiment.

17. The system of claim 13, wherein the processor is configured to:
find an identity of the publisher in a customer database of the entity; and
adjust the initiated interaction according to the identity of the publisher.

18. The system of claim 17, wherein the processor is configured to find the identity of the publisher by:
extracting attributes from a profile of the publisher, wherein each attribute is associated with an importance level;
selecting at least one of the attributes based on the importance level of the attributes;
using the selected attributes as keywords for searching the customer database for an identity of the publisher; and
associating a confidence score to the identity of the publisher, wherein the confidence score is indicative of chances that the identification is correct.

19. The system of claim 13, wherein the processor is configured to monitor the at least one social media channel by:
finding a first post on the at least one social media channel that includes at least part of the content that is relevant to the entity;
finding related posts by the same publisher;
finding responses to the first post and to the related posts;
extracting keywords from the first post, the related posts and the responses; and
providing the keywords to a machine learning (ML) model that has been trained to identify sentiment from the keywords and a confidence level of the identified sentiment.

20. The system of claim 13, wherein the processor is configured to:
analyze the content with the negative sentiment to identify a problem;
retrieve from a client database a communication channel and contact information of the publisher;
retrieve from a database of known problems a mitigation that is associated with the identified problem;
select from a database of agents and associated skills the agent that is associated with skills relevant to at least one of the problem, the publisher and the communication channel; and
schedule a work item for the agent, wherein the work item comprises the communication channel, the contact information and the mitigation.
